(19) United States
(12) Patent Application Publication
(10) Pub. No.: US 2005/0117626 A1
(43) Pub. Date: Jun. 2, 2005

(54) Thermometer

(76) Inventors: Isamu Kobayashi, Tokyo (JP); Heihachiro Ebihara, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/495,331

(22) PCT Filed: Nov. 20, 2002
(86) PCT No.: PCT/JP02/12103

(30) Foreign Application Priority Data
Nov. 20, 2001 (JP) 2001-354010

(51) Int. Cl. G01K 7/00

(52) U.S. Cl. 374/163

(57) ABSTRACT

A heat collecting member of a thermometer, such as a clinical thermometer, is formed of a titanium-based material or a metallic base material of which the surface is coated with the titanium-based material.

### TECHNICAL FIELD

The present invention relates to a thermometer for measuring the temperature of a living body or the like.

### BACKGROUND ART

Conventionally, an electronic clinical thermometer is used to measure the temperature of the human body. This electronic clinical thermometer comprises a body having a temperature display unit, a probe integral with the body, and a heat collecting member that has a temperature sensor, such as a thermistor, therein. The heat collecting member is attached to the probe so that it can be brought directly into contact with the human body. The configuration in which a heat collecting member is attached to the probe is used in a conventional thermometer that measures atmospheric temperature, water temperature, or the temperature of any other object of temperature measurement, as well as in the electronic clinical thermometer.

The heat collecting member has a function to feed heat received from the object of measurement into the temperature sensor. A typical material that is conventionally used for the heat collecting member of a miniature thermometer or electronic clinical thermometer is a stainless steel material. Austenite materials, such as SUS304, are generally used for the purpose. These materials enjoy practically appropriate strength, outstanding resistance to corrosion, nonmagnetic property, and good workability.

A clinical thermometer requires short-time measurement. Presently, however, every conventional clinical thermometer except an infrared-detection type never enjoys a measuring time that is short enough. On the other hand, clinical thermometers of the infrared-detection type are liable to errors in measured temperature, depending on the measuring method.

In the case of a clinical thermometer, moreover, its metallic heat collecting member directly touches the skin (armpit or mouth) of the human body. Since the stainless steel material contains about 8% of nickel, however, it may be subject to the problem of metal allergy, on rare occasions. In some thermometers or electronic clinical thermometers, an aluminum alloy (e.g., A5056 or the like) is used for the heat collecting member. The aluminum alloy does not contain nickel that has very high heat conductivity and causes metal allergy. If it is used for the heat collecting member of a clinical thermometer, in particular, therefore, the problems of the measuring time and metal allergy can be solved at a stroke. Thus, the aluminum alloy can be regarded as ideal.

However, the aluminum alloy can be easily corroded by acids and alkalis. If it is used for an electronic clinical thermometer that directly touches the skin (armpit or mouth) of the human body, therefore, the thermometer must be cleaned with a neutral detergent or the like after use. Accordingly, handling the aluminum alloy is troublesome if it is used for the clinical thermometer. In some conventional thermometers, the heat collecting member may also touch the human body or be used to measure the temperature of acid or alkaline substances, though not so frequently as the electronic clinical thermometer. If the aluminum alloy is used for such a conventional thermometer, therefore, the thermometer shares the same problem with the electronic clinical thermometer.

### DISCLOSURE OF THE INVENTION

The object of the present invention is to provide a thermometer, such as a clinical thermometer, capable of shortening the measuring time, not arousing any problem such as metal allergy though touched to a human body, requiring no frequent cleaning, and therefore, entailing no troublesome handling.

First, the temperature measurement characteristic of a thermometer (clinical thermometer) will be described with reference to FIG. 5.

FIG. 5 shows the temperature indicated by a temperature sensor of the clinical thermometer as a function of time. A curve 100 in FIG. 5 represents the temperature measurement characteristic of a conventional clinical thermometer.

The inventors hereof first tried to reduce the heat capacity by lessening the volume of the temperature sensor as means for shortening the measuring time. This is based on a concept that the smaller the heat capacity of the temperature sensor, the faster the temperature rise of the temperature sensor is, on the condition that the quantity of heat collected by means of the heat collecting member is constant.

Thereupon, temperature measurement was tried with use of a temperature sensor smaller in size than conventional ones. A curve 200 in FIG. 5 represents the result. Comparison the curves 100 with the curve 200 tells that the initial rise of the curve 200 immediately after the measurement is obviously faster than that of the curve 100. This implies a limitative effect of the miniaturization of the temperature sensor.

As the measured temperature approaches saturation temperature, however, the rise of the curve slows down. In about 15 seconds after the start of the measurement, the curve 200 substantially coincides with the curve 100. By this point of time, however, a measurable temperature (temperature very close to the saturation temperature) is not reached yet. Accordingly, even if the temperature sensor is made smaller than a conventional one, the time from the start of measurement to the attainment of the measurable temperature does not change.

The above results may be attributed to several factors. First, heat collection by means of the heat collecting member may be supposed to be unsatisfactory. If the quantity of heat collected is inadequate, the temperature sensor cannot be supplied with sufficient heat, so that the temperature rise of the temperature sensor may possibly be retarded. Secondly, the heat conductivity of the heat collecting member may be supposed to be unsatisfactory. If it takes a long time for a collected heat to reach the temperature sensor, the temperature rise of the temperature sensor may possibly be retarded. Thirdly, the collected heat may be supposed to have escaped to any other portion than the temperature sensor, e.g., a mounting portion for the heat collecting member. Otherwise, the heat supplied to the temperature sensor may be supposed to have leaked through a lead wire that connects the temperature sensor and a circuit. Further, the temperature rise of the heat collecting member itself may be supposed to be slow.

Very satisfactory results were obtained when the material of the heat collecting member was replaced with aluminum, which is used for some thermometers, as mentioned before, to clear up the cause. As mentioned before, however, the use of aluminum for a clinical thermometer involves drawbacks, such as liability of corrosion to oxygen and alkalis. If the reason why aluminum produces good results is known, aluminum can be replaced with any other material that produces the same results as aluminum.

The most striking known feature of aluminum is its very high heat conductivity. While the heat conductivity of stainless steel is 16.3 W/mK, that of aluminum is 120 W/mK.

If the reason why aluminum produces the good results is attributable to the high heat conductivity of aluminum, any other method which could transmit the heat of the heat collecting member to the temperature sensor in a short time should be adopted. In view of the above, the temperature sensor was transferred from the distal end of the heat collecting member to the inner wall of the heat collecting member near its center, the flank of the temperature sensor was fixed to the heat collecting member, an iron wire was used in place of a copper wire as the lead wire of the temperature sensor, and a hollow of the heat collecting member was hermetically sealed. Thereupon, it was found that the initial temperature rise was improved. However, it was also found that the time required for reaching the saturation temperature was not so improved as in the case of aluminum.

The results of the investigation were reviewed, and it was found that the reason why the good results had been obtained with aluminum might be attributable to the reduction of the heat capacity of the heat collecting member, rather than the high heat conductivity. The specific gravity and specific heat of SUS304 are 7.93 g/cm³ and 0.120 cal/g·° C., respectively, so that the heat capacity per unit volume is 0.952 cal/° C. On the other hand, the specific gravity and specific heat of aluminum are 2.64 g/cm³ and 0.217 cal/g·° C., respectively, so that the heat capacity per unit volume is 0.573 cal/° C.

If the heat capacity of the heat collecting member is too large, the temperature rise of the heat collecting member is retarded naturally. If the heat supply is not fixed, as in the case of a living body, besides this, the temperature of the living body surface is lowered due to contact with the heat collecting member. Thus, attainment of thermal equilibrium may possibly require a very long time.

The inventors hereof sought a material that has heat capacity per unit volume approximate to 0.573 cal/° C., that of aluminum, and obtained a titanium material. The specific gravity and specific heat of pure titanium are 4.51 g/cm³ and 0.124 cal/g·° C., respectively. Accordingly, the heat capacity per unit volume is 0.559 cal/° C., which is approximate to 0.573 cal/° C. or the heat capacity per unit volume of aluminum. Incidentally, the heat conductivity of aluminum is 120 W/mK, while that of the titanium material is only 17.1 W/mK.

The inventors hereof used a titanium material to manufacture a heat collecting member having the same size as the heat collecting member with which the curve 100 of FIG. 5 was obtained, and made a similar measurement. A curve 300 in FIG. 5 represents the result. This curve 300 is similar to the curve for the case where an aluminum heat collecting member is used for a clinical thermometer.

Considering the above-mentioned views, in a thermometer comprising a temperature sensor, the metallic heat collecting member to which the temperature sensor is fixed and which covers the temperature sensor, and computing means for computing the temperature of an object of temperature measurement in accordance with the output of the temperature sensor, the heat collecting member is formed of a titanium-based material, in the case of the present invention. Further, the heat collecting member has a metallic base material of which the surface is coated with a titanium-based material by a vapor deposition method.

The present invention may assume the following aspects.

The titanium compound covers only the exposed surface of the metallic base material.

The metallic base material is a metal having heat conductivity higher than that of the titanium-based material for coating.

The metallic base material is aluminum.

The metallic base material has a hollow inside, and the temperature sensor is fixed to that part of the inner wall of the hollow which is not coated with the titanium-based material.

The titanium-based material is pure titanium.

The titanium-based material is a titanium alloy.

The titanium-based material is a titanium compound.

The titanium compound is titanium nitride.

The titanium compound is titanium carbide.

The titanium-based material is titanium oxide.

The object of measurement is a living body, and the computing means computes the temperature of the living body.

According to the present invention, as described above, the heat collecting member is formed of the titanium-based material. Accordingly, there may be provided a thermometer of very high quality, which never causes metal allergy, is never corroded by acids or alkalis, and ensures short-time measurement. Further, the surface of the metallic base material of the heat collecting member is coated with the titanium-based material by the vapor deposition method. Therefore, favorable effects of the metal that serves as the base material can be utilized to make up for drawbacks of the base material and to form the heat collecting member with ease.

### BRIEF DESCRIPTION OF THE DRAWINGS

FIG. 1 is a sectional view of a probe portion of a thermometer (electronic clinical thermometer) according to a first embodiment of the present invention;

FIG. 2 is a sectional view of a probe portion of a thermometer (electronic clinical thermometer) according to a second embodiment of the present invention;

FIG. 3 is an exterior view of a thermometer (electronic clinical thermometer) according to an embodiment of the present invention;

FIG. 4 is a sectional view of a probe portion of a thermometer (electronic clinical thermometer) according to a third embodiment of the present invention;

FIG. 5 is a diagram showing the temperature measurement characteristic of the thermometer;

FIG. 6A is a sectional view of a probe portion of a thermometer (electronic clinical thermometer) according to a fourth embodiment of the present invention; and

FIG. 6B is a partial enlarged view of a heat collecting element of the probe portion shown in FIG. 6A.

### BEST MODE FOR CARRYING OUT THE INVENTION

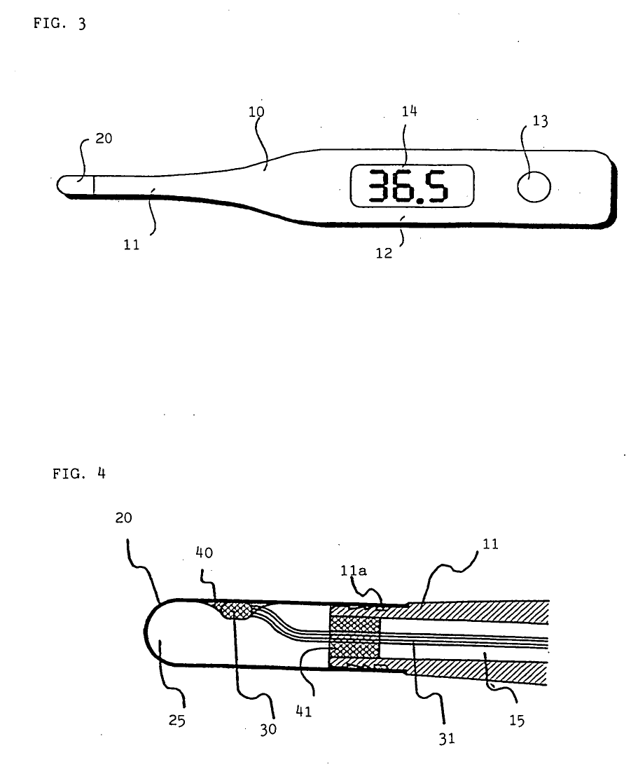

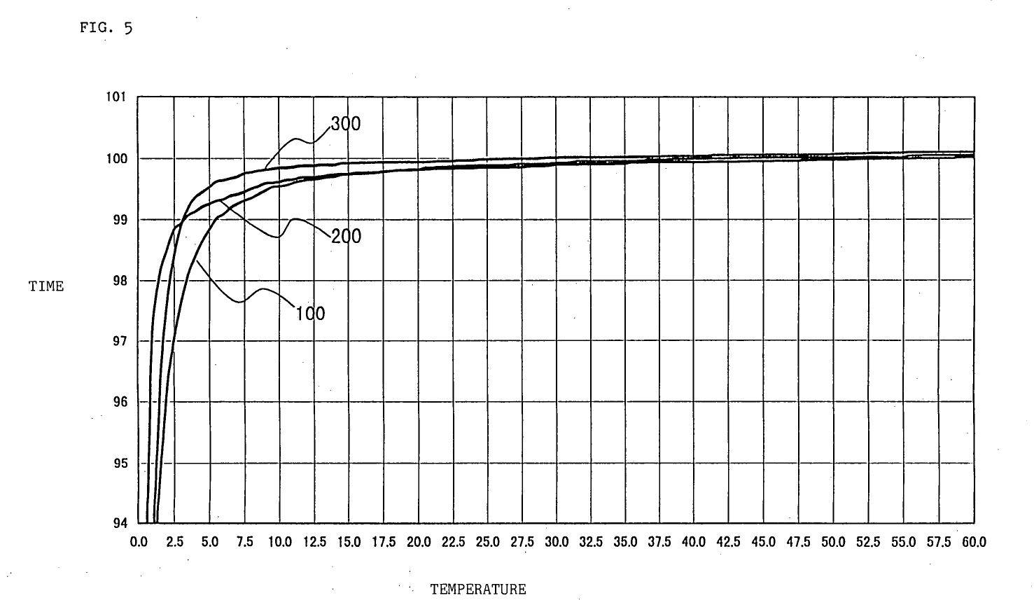

First, an exterior view of an electronic clinical thermometer according to the present invention will be described with reference to FIG. 3.

A contact-type electronic clinical thermometer 10 comprises a body section 12 having a probe portion 11 to be inserted into a measured region of a living body, such as the armpit, and a metallic heat collecting member 20 that is attached to the distal end of the probe portion 11. The material of the body section 12 is ABS resin, for example, and the material of the heat collecting member 20 is pure titanium, titanium alloy, or titanium compound. Titanium-based materials described in the present specification or the appended claims include pure titanium, titanium alloys, and titanium compounds. As mentioned later, moreover, the heat collecting member 20 is in the form of a cap, and has a temperature sensor, such as a thermister, therein. Its interior is hollowed so that its heat capacity is reduced to enable short-time measurement.

The body section 12, which is covered by an outer casing, is partially provided with a switch 13 for starting measurement and a display unit 14 for displaying a measured temperature value. Further, the body section 12 has therein an electric circuit (not shown) that includes computing means for computing the bodily temperature in accordance with the measured value of the temperature sensor.

A method of operating the electronic clinical thermometer according to the present embodiment will now be described with reference to FIG. 3. If the switch 13 is depressed, first, the electronic clinical thermometer 10 is switched on in response to this operation, whereupon it is ready to start measurement. Then, the heat collecting member 20 on the distal end of the probe portion 11 is brought into contact with the measured region of the living body. In a fixed time after the probe portion 11 is securely held in the armpit to measure the underarm temperature, a buzz or the like tells termination of the measurement, and the measured temperature value is displayed on the display unit 14. The electronic clinical thermometer 10 is taken out of the armpit, and the temperature value on the display unit 14 is read. Finally, the switch 13 is depressed to disconnect the electronic clinical thermometer 10 from the power supply.

The following is a description of first to third embodiments of the thermometer according to the present invention. These embodiments are characterized in the internal structures of the heat collecting member 20 and the probe portion 11 of the electronic clinical thermometer shown in FIG. 3.

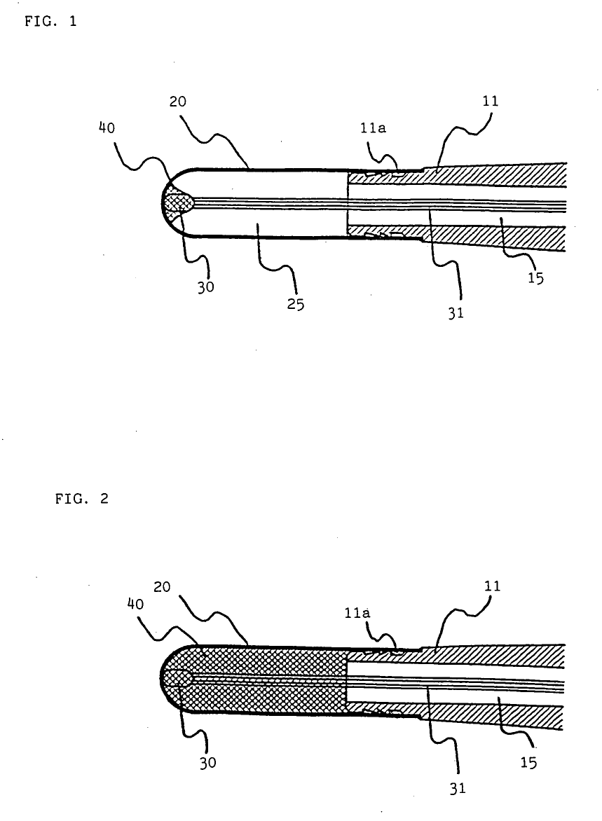

First, the first embodiment of the thermometer (electronic clinical thermometer) will be described with reference to the sectional view of FIG. 1.

A hollow 25 is formed in the heat collecting member 20 so that the heat capacity of the heat collecting member 20 is reduced to enable short-time measurement. The distal end portion of a temperature sensor 30 is fixed to the inner wall of the hollow 25 with an adhesive agent 40. Thus, the temperature sensor 30 is covered by the heat collecting member 20. The hollow 25 is filled with air. A groove 11a is formed on the distal end portion of the probe portion 11. The groove 11a is filled with an adhesive agent for fixing the heat collecting member 20 to the distal end of the probe portion 11. Further, a hollow 15 is formed in the probe portion 11, and a temperature sensor lead wire 31 is disposed in the hollow 15.

The following is a description of a feature that is obtained by using the titanium-based material for the heat collecting member 20. Since the heat collecting member 20 is formed of a titanium-based material, which, unlike a stainless steel material, contains no nickel, it causes no metal allergy. Unlike aluminum, furthermore, the material is highly resistant to acidic corrosion, so that it cannot be corroded with ease. Besides, the titanium-based material can enjoy practically appropriate strength as high as that of the stainless steel material.

The specific gravities and specific heats of titanium alloys slightly vary depending on their types, and are about 4.5 g/cm³ and 0.13 cal/g·° C., respectively, which are substantially equal to those of pure titanium. Titanium requires less heat quantity to increase the temperature by 1° C. per unit volume than stainless steel does. Therefore, the heat collecting member 20 deprives the measured region of the human body of less heat during temperature measurement. This implies that a titanium heat collecting member feels less chilly than a stainless-steel heat collecting member during the temperature measurement.

If the heat collecting member is formed of the titanium-based material in this manner, it is free from the problem of metal allergy of the stainless-steel heat collecting member and the problem of the liability of the aluminum heat collecting member to corrosion by acids or alkalis, and the measuring time is shortened considerably. Like the stainless-steel heat collecting member, moreover, the titanium heat collecting member can enjoy practically appropriate strength and never easily feels chilly during the temperature measurement. Thus, it also has an effect that it less frequently gives a subject of measurement an unpleasant feeling.

The second embodiment of the thermometer (electronic clinical thermometer) will now be described with reference to the sectional view of FIG. 2. Like numerals are used to designate the same components of this embodiment and the embodiment shown in FIG. 1, and a description of those components is omitted.

This embodiment is equivalent to a configuration obtained by filling the heat collecting member 20 of the thermometer of the first embodiment of FIG. 1 with a heat insulating resin 40. If the resin 40 is loaded into the heat collecting member 20, the mechanical strength can be enhanced, although the heat capacity of the whole heat collecting member portion slightly increases. Therefore, the wall thickness of the heat collecting member can be lessened, and the heat capacity of the heat collecting member itself can be reduced. Thus, the effect of the use of the titanium-based material for the heat collecting member 20 can be made equal to or higher than that of the first embodiment shown in FIG. 1, and a clinical thermometer having high mechanical strength can be provided.

The third embodiment of the thermometer (electronic clinical thermometer) will now be described with reference to the sectional view of FIG. 4. Like numerals are used to designate the same components of this embodiment and the embodiments shown in FIGS. 1 and 2, and a description of those components is omitted.

A heat collecting member 20 used in this embodiment is constructed in the same manner as the heat collecting member 20 used in the first embodiment.

In the first embodiment (FIG. 1) and the second embodiment (FIG. 2), the temperature sensor is fixed to the distal end portion of the heat collecting member 20. In this embodiment, however, a temperature sensor is fixed substantially to the central portion of the inner wall of the heat collecting member 20 with respect to the longitudinal direction. In the first and second embodiments, moreover, the distal end portion of the temperature sensor is fixed to the inner wall of the heat collecting member 20. In this embodiment, however, the flank portion of the temperature sensor is fixed to the inner wall of the heat collecting member 20. In this embodiment, furthermore, the material of a lead wire 31 is an iron wire that has low heat conductivity. Further, a hollow 25 is hermetically sealed with an adhesive agent 41 or resin so that air therein is cut off from air in a hollow 15 of a probe portion 11.

Since the temperature sensor is mounted substantially on the central portion of the inner wall of the heat collecting member 20 with respect to the longitudinal direction, the time of heat conduction from various parts of the heat collecting member to the temperature sensor is shortened. Since the flank portion of the temperature sensor is attached to the heat collecting member, moreover, the efficiency of heat conduction form the heat collecting member to the temperature sensor is also improved. Since the temperature sensor lead wire 31 is an iron wire, moreover, heat that escapes from the temperature sensor 30 through the temperature sensor lead wire 31 is reduced. Further, since the air in the hollow 25 is confined, the quantity of heat that escapes into the hollow 15 of the probe portion 11 lessens. Thus, the rise of the temperatures of the heat collecting member 20 and the temperature sensor 30 is hastened, so that the measuring time can be shortened. This embodiment also has an effect for the case where the heat collecting member is the conventional stainless-steel member.

The heat collecting member 20 of any of the thermometers of the first to third embodiments described above is formed entirely of pure titanium or a titanium alloy.

The conventional stainless-steel heat collecting member used to be made in a manner such that a flat plate of SUS304 with a thickness of 0.1 mm or more, for example, is gradually formed into a cap by multistage deep drawing with which the plate is drawn into a hole of a die by the agency of a punch.

Likewise, the heat collecting members shown in FIGS. 1 to 4 can be formed by subjecting a flat plate of a titanium material or titanium alloy with a thickness of 0.1 mm or more to multistage deep drawing. In general, all these heat collecting members but special ones are very small, having a diameter of about 3 mm and length of about 7 mm. Also used is a heat collecting member which can shorten the measurement time more by increasing the length to about 9 mm, while maintaining the diameter of about 3 mm, so as to increase the area of contact with the human body. Although the multistage deep drawing is an easy work if the heat collecting member is short, it requires the number of drawing steps to be increased if the length is increased.

Further, the distal end portion of the heat collecting member is formed hemispherical, and its thickness must be adjusted with accuracy within a given range lest the measuring time be subject to variation. Thus, the heat collecting member that is longer than a conventional heat collecting member, in particular, can be worked relatively easily by increasing the drawing steps if the material SUS304 has a draw of 60% as an indication of the ease of multistage deep drawing. In order to shape pure titanium or titanium alloy with a draw of about 30% in this manner, however, the drawing can be carried out only little by little spending time by increasing the drawing steps to a number many times as large as the number of steps for SUS, and it is not easy (in this case, the “draw (%)” is represented by (A−Az)×100/A, where Az is a cross section area obtained when the material is pulled and snapped and A is a cross section area obtained before the material is pulled).

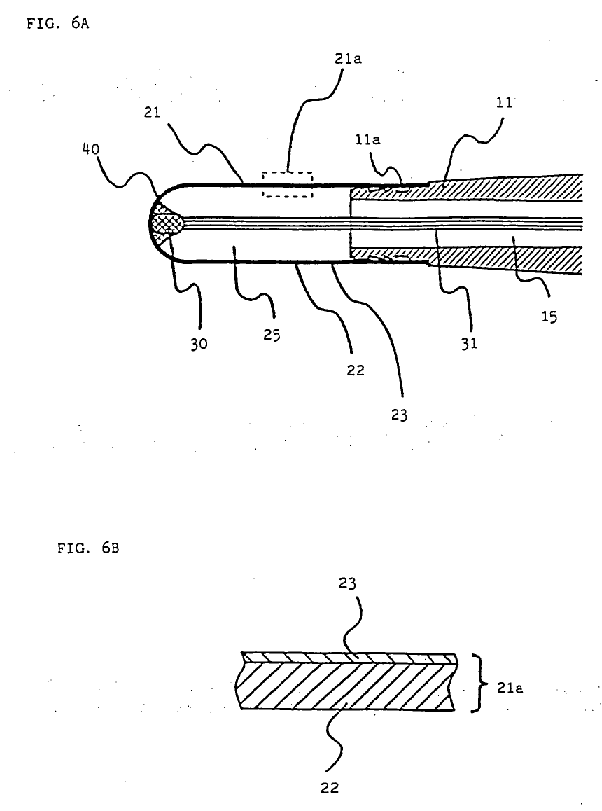

A clinical thermometer (electronic clinical thermometer) according to a fourth embodiment, which has the same effect of the heat collecting member that is formed of a titanium material only and of which the heat collecting member can be manufactured relatively easily, will now be described with reference to FIGS. 6A and 6B.

FIG. 6A is a sectional view of a probe portion of the clinical thermometer according to the fourth embodiment, and FIG. 6B is an enlarged view showing a part (21a) of a heat collecting member 21 shown in FIG. 6A. Like numerals are used to designate the same components of the embodiment shown in FIGS. 6A and 6B and the embodiment shown in FIG. 1, and a description of those components is omitted.

In this embodiment, the heat collecting member 21 is not composed of a titanium material only, but is composed of a base material 22 formed of Aluminum material and a titanium compound 23 with which its exposed outer surface is coated. The base material 22 is formed by the same working method (e.g., cutting of a rod-shaped aluminum material) for the conventional aluminum heat collecting member. The exposed outer surface of the base material 22 is coated with the titanium compound 23 by a physical vapor deposition method such as ion plating. For example, nitrogen (N₂) as a reactive gas is injected into a vacuum layer in which the base material 22 is confined, it is divided between ions and electrons to generate plasma, and titanium is evaporated. Thereupon, evaporated particles of titanium and nitrogen become ions in the plasma so that chemical reaction is promoted. The titanium particles and nitrogen in the form of ions are accelerated and run against the base material 22 to which negative electrons are applied, with high energy, and bite as titanium nitride, a titanium compound, into the material surface to be deposited thereon. In carrying out the ion plating, an opening portion of the base material 22 is closed lest the interior of the hollow 25 be coated with titanium nitride.

Coating the titanium compound by the ion plating is a technique that has already been put to practical use in the field of metallic wristbands of wristwatches, for example, and can be carried out with ease.

The reactive gas is not limited to nitrogen and may be any other gas that allows the titanium compound to adhere to the surface of the base material 22. For example, the base material 22 may be coated with titanium carbide or titanium oxide, a titanium compound that is different from titanium nitride, by the use of a reactive gas that is different from nitrogen. Any other physical vapor deposition method than ion plating or other method may be used only if the base material 22 can be coated with titanium. Further, the surface of the base material 22 may be coated with pure titanium or a titanium alloy.

Coating the base material 22 with the titanium compound 23 (titanium nitride) can make up for the liability of aluminum to corrosion. As mentioned before, aluminum is a metal that is substantially equal to pure titanium or a titanium alloy in heat capacity per unit volume and higher than titanium in heat conductivity. The titanium alloy that covers aluminum has a thickness of several microns and influences the measuring time little. Therefore, the temperature can be measured in such a short measuring time as in the case where the heat collecting member is formed of aluminum only or the case where the heat collecting member is formed of a titanium material only.

The inner wall of the hollow 25 in the base material 22 may be also coated with the titanium compound 23. However, heat can be more easily transmitted to the temperature sensor 30 if aluminum that is higher than a titanium compound in heat conductivity is exposed in the hollow 25 so that the temperature sensor 30 can be fixed to the exposed portion.

The material of the base material 22 is not limited to aluminum, and may alternatively be stainless steel, for example. As mentioned before, for example, a cap-shaped base material may be formed by subjecting SUS304 to multistage deep drawing. In this case, its outer surface or whole surface is coated with a titanium compound by vapor deposition. If the surface of the stainless steel is coated with the titanium compound, a heat collecting member that is free from metal allergy can be constructed taking advantage of the high strength of stainless steel.

The hollow 25 of the base material 22 according to the fourth embodiment may be filled with a resin, as in the second embodiment shown in FIG. 2, or hermetically sealed, as in the third embodiment shown in FIG. 4. Further, the temperature sensor 30 according to the fourth embodiment may be fixed substantially to the center of the inner wall of the heat collecting member 22 with respect to the longitudinal direction, as in the third embodiment, or the flank of the temperature sensor 30 may be attached to the inner wall of the heat collecting member 22.

By coating the surface of the metallic base material 22 with the titanium compound in this manner, favorable effects of the metal that serves as the base material can be utilized to make up for drawbacks of the base material 22. Thus, the same effects of the heat collecting member that is formed of a titanium material only can be obtained, and the heat collecting member can be formed with ease.

Although the electronic clinical thermometer has been described as an example of the thermometer according to the present embodiment, it is to be understood that the present invention is not limited to this and is also applicable to a conventional thermometer.

1. A thermometer comprising a temperature sensor, a metallic heat collecting member to which the temperature sensor is fixed and which covers the temperature sensor, and a computing unit for computing the temperature of an object of temperature measurement in accordance with the output of the temperature sensor, wherein
said heat collecting member is formed of a titanium-based material.

2. A thermometer comprising a temperature sensor, a metallic heat collecting member to which the temperature sensor is fixed and which covers the temperature sensor, and a computing unit for computing the temperature of an object of temperature measurement in accordance with the output of the temperature sensor, wherein
said heat collecting member has a metallic base material of which the surface is coated with a titanium-based material by a vapor deposition method.

3. The thermometer according to claim 2, wherein said titanium-based material covers only the exposed surface of the metallic base material.

4. The thermometer according to claim 2 or 3, wherein said metallic base material is a metal having heat conductivity higher than that of the titanium-based material for coating.

5. The thermometer according to claim 4, wherein said metallic base material is aluminum.

6. The thermometer according to claims 2 and 3, wherein said metallic base material has a hollow inside, and the temperature sensor is fixed to that part of the inner wall of the hollow which is not coated with the titanium-based material.

7. The thermometer according to any one of claims 1 to 3, wherein said titanium-based material is pure titanium.

8. The thermometer according to any one of claims 1 to 3, wherein said titanium-based material is a titanium alloy.

9. The thermometer according to any one of claims 1 to 3, wherein said titanium-based material is a titanium compound.

10. The thermometer according to claim 9, wherein said titanium compound is titanium nitride.

11. The thermometer according to claim 9, wherein said titanium compound is titanium carbide.

12. The thermometer according to claim 9, wherein said titanium-based material is titanium oxide.

13. The thermometer according to any one of claims 1 to 3, wherein said object of titanium measurement is a living body, and the computing means computes the temperature of the living body.
